(19) United States
(12) Patent Application Publication
(10) Pub. No.: US 2014/0050208 A1
(43) Pub. Date: Feb. 20, 2014

(54) APN IP MANAGEMENT

(71) Applicant: STOKE, INC., Santa Clara, CA (US)

(72) Inventors: Sashidhar Annaluru, Cupertino, CA (US); Mukesh Garg, Cupertino, CA (US); Tamanna Jindal, Bangalore (IN); John Carvalho, Malvern, PA (US)

(73) Assignee: STOKE, INC., Santa Clara, CA (US)

(21) Appl. No.: 13/715,523

(22) Filed: Dec. 14, 2012

Related U.S. Application Data
(60) Provisional application No. 61/683,146, filed on Aug. 14, 2012.

(51) Int. Cl. H04W 84/12

(52) U.S. Cl. CPC H04W 84/12
USPC 370/338

(57) ABSTRACT

In one embodiment, a WLAN gateway (WGW) receives a dynamic host configuration protocol (DHCP) request from a WLAN controller for an IP address of a user equipment (UE). In one embodiment, DHCP server within the WGW assigns a local IP (LIP) address to the UE from a pool of local IP addresses maintained by the DHCP server. The WGW communicates the UE LIP address to the WLAN controller, wherein the UE LIP address is used by the WLAN controller to identify traffic to/from the UE while the UE is communicatively coupled to the WLAN and exchange the DE traffic between WGW and WLAN controller. In one embodiment, the WGW is configured to perform network address translation between the UE LIP and an external IP address assigned by one or more networks of the mobile network operator (MNO) to allow the UE to reach the network(s) in addition to the Internet.

### CROSS-REFERENCE TO RELATED APPLICATIONS

This application claims the benefit of U.S. Provisional Application No. 61/683,146, filed Aug. 14, 2012, which is hereby incorporated by reference.

### FIELD OF THE INVENTION

Embodiments of the present invention relate generally to packet networks. More particularly, this invention relates to a method for managing access point name (APN) and Internet protocol (IP) address.

### BACKGROUND

In the last decade Wi-Fi has become the networking technology of choice at home and at enterprises for wireless users. It is also abundantly present at locations of nomadic computing such as cafes, airports and hotels. The umbrella wireless coverage is usually from macro-cellular network but the cost of carrying wireless data is significantly higher on macro-cellular network.

Many modern devices used by mobile user base (e.g., Smartphone, tablet, and laptop) are capable of using both Wi-Fi and cellular network. So it would seem logical to provide a seamless connectivity service that uses these complementary networks efficiently. Under the umbrella of fixed mobile convergence, there have been many efforts by the industry and by standards bodies to address this need. The interworked WLAN (IWLAN) is one such effort that is standardized by the third generation partnership project (3GPP). Even though IWLAN is an end to end solution complete with standardized architecture and protocols, it has basic shortcomings.

Under conventional architectures of packet core network (CN) that involve mobile devices connecting to the CN via a Wi-Fi Access Point (AP), all Internet protocol (IP) addresses and access point names (APNs) are managed by the CN. Thus, every time a mobile device connects to a mobile network operator's Wi-Fi hotspot, authentication must be performed with the CN. This is an undue, sometimes overwhelming, load on the CN. The overloading effect on the CN is most severe in cases where many mobile devices are moving in and out of the Wi-Fi network frequently, thus causing the CN to experience a signaling storm. Conventional architectures of CN also suffer another shortcoming regarding simultaneous connectivity to multiple APNs. Wi-Fi access mechanism of conventional architectures does not permit multiple simultaneous APNs connectivity as it is possible on a 3GPP network. This is a significant limitation with Wi-Fi networks served by a mobile operator.

### BRIEF DESCRIPTION OF THE DRAWINGS

Embodiments of the invention are illustrated by way of example and not limitation in the figures of the accompanying drawings in which like references indicate similar elements.

FIGS. 1 is a block diagram illustrating an internetworked WLAN and WWAN system according to one embodiment.

FIG. 2 is a block diagram illustrating an embodiment of an access point name database.

FIG. 3 is a block diagram illustrating an embodiment of a network address translation database

FIG. 4 is a flow diagram illustrating a method for performing network address translation to enable a UE to reach one or more APNs in addition to the Internet.

FIG. 5 is a transaction diagram illustrating a processing flow for authenticating and assigning a LIP address to a UE according to one embodiment of the invention.

FIG. 6 is a transaction diagram illustrating a process flow for data traffic to be exchanged between a UE and a host server according to one embodiment.

FIG. 7 is a block diagram illustrating a WLAN gateway device according to one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments of the invention, an architecture and set of mechanisms are provided to enable a packet core network (CN), such as a 3GPP network, avoid signaling overhead caused by mobile user equipment (UE), e.g., Wi-Fi devices, authenticating with the CN every time they move in and out of a wireless network, such as a Wi-Fi network, which is communicatively coupled to the CN. In one embodiment of the invention, an architecture and set of mechanisms are also provided to enable UEs to connect to one or more services provided by a network operator, such as a mobile network operator (MNO). In one embodiment, the mechanisms may require capabilities in a wireless local area network (WLAN) controller, such as a Wi-Fi controller, to interact with a WLAN gateway (WGW) coupling a WLAN with the Internet and/or a packet core network. However, the WLAN entity in the user device does not have to change the way it communicates with another entity. Nor would there be a burden on the user device to run end-to-end IPSec tunnel with a 3GPP network (e.g., a 3G or LTE network). Each network operates in its native manner while the correlation and internetworking responsibilities are borne by the WGW. Any system can securely identify and maintain a session with a WLAN endpoint using conventional associated communications mechanism. The WGW, on the other hand, with its wireless wide area network (WWAN) protocol (e.g., 3GPP protocol) abilities can interact with a WWAN subscriber database (e.g., HSS/3GPP authentication, authorization and accounting server) and/or one or more packet data network gateways (PDN GWs). Throughout this application, a Wi-Fi network is described as an example of a WLAN while a 3GPP network is described as an example of a WWAN network. However, it is not so limited; the techniques described herein can also be applied to other types of WLANs and/or WWANs.

According to one embodiment, when a UE transmits a DHCP request to the WGW via a WLAN controller, the WGW invokes an authentication, authorization and accounting (AAA) server of the MNO to authenticate the UE. In one embodiment, the AAA server determines if the UE is a customer of the MNO, and if so, the authenticated UE is granted default permissions, for example, access to the Internet. In one embodiment, the AAA server may also grant the authenticated UE other MNO hosted service(s) according to the service level the UE is eligible for. In one embodiment, when the AAA server determines that the authenticated UE is entitled to one or more of the MNO's hosted services, the AAA server returns the access point names (APNs) of the services that the authenticated UE is allowed to access. In one embodiment, the APNs are maintained in a local APN database maintained by the WGW. According to one aspect of the invention, a set of one or more domain names and/or IP subnet addresses of the host servers of the APN(s) hosting the operator services that the authenticated UE is allowed to access are also returned by AAA server. In another embodiment, the APN associated domain names and/or IP addresses are pre-provisioned in the WGW. In one embodiment, the set of one or more domain names and/or IP subnet addresses of the host servers are also maintained by the WGW in a local APN database maintained by the WGW.

In one embodiment, once a UE is authenticated, a DHCP server within the WGW assigns a local IP (LIP) address to the authenticated UE, wherein the LIP address is an IP address selected from a pool of local IP addresses maintained by the DHCP server. In one embodiment, the WGW communicates the LIP address, e.g., by transmitting it in a DHCP response, to the WLAN controller, which, in one embodiment, is used by WLAN controller to identify traffic to/from the UE while the UE is communicatively coupled to the WLAN network and exchange the UE traffic between the WGW and WLAN controller.

In one embodiment, an authenticated UE attempts to access a granted hosted service by transmitting a DNS request for an IP address of a domain name, i.e., the host server hosting the service. In one embodiment, when the DNS request is received by the WGW, the WGW looks up the local APN database to determine if the domain name is within a range of domains that the UE is allowed to access. In one embodiment, if the WGW determines that the UE is allowed to access the requested service, i.e., the requested domain name is within a range of domain names that UE has access to, the WGW establishes a tunnel, e.g., a GPRS tunneling protocol user plane (GTP-U) tunnel, with a PDN GW, wherein the PDN GW is selected based on the APN corresponding to the desired domain name, as indicated in the APN database. In one embodiment, upon completing the tunnel establishment, the WGW will receive an external IP address from the PDN GW that is assigned to the UE, which is maintained by the WGW in a local network address translation (NAT) database. In one embodiment, the external IP address is assigned to the UE by a DHCP server of the APN.

In one embodiment, after a tunnel is established, the WGW forwards the DNS request originated from the UE to the selected PDN GW which, in turn, forwards it to its local DNS server. In response, the DNS server of the APN provides the IP address of the requested domain name, which is communicated to the UE by the PDN GW, e.g., by transmitting it in a DNS response frame to the UE.

In one embodiment, subsequent data traffic between the UE and the host server passes through the WGW, which performs network address translation between the UE LIP address assigned by the WGW and one or more external IP addresses assigned to the UE by one or more PDN GWs of the MNO, thus allowing the UE to reach one or more APNs in addition to the Internet.

In one embodiment, when the last IP session termination is initiated by a PDN GW, UE, or timeout, the GTP-U tunnel between the WGW and the PDN GW is torn down. In one embodiment, the WGW will also release the external IP address assigned to the UE by the PDN GW, e.g., by sending a message to the PDN GW.

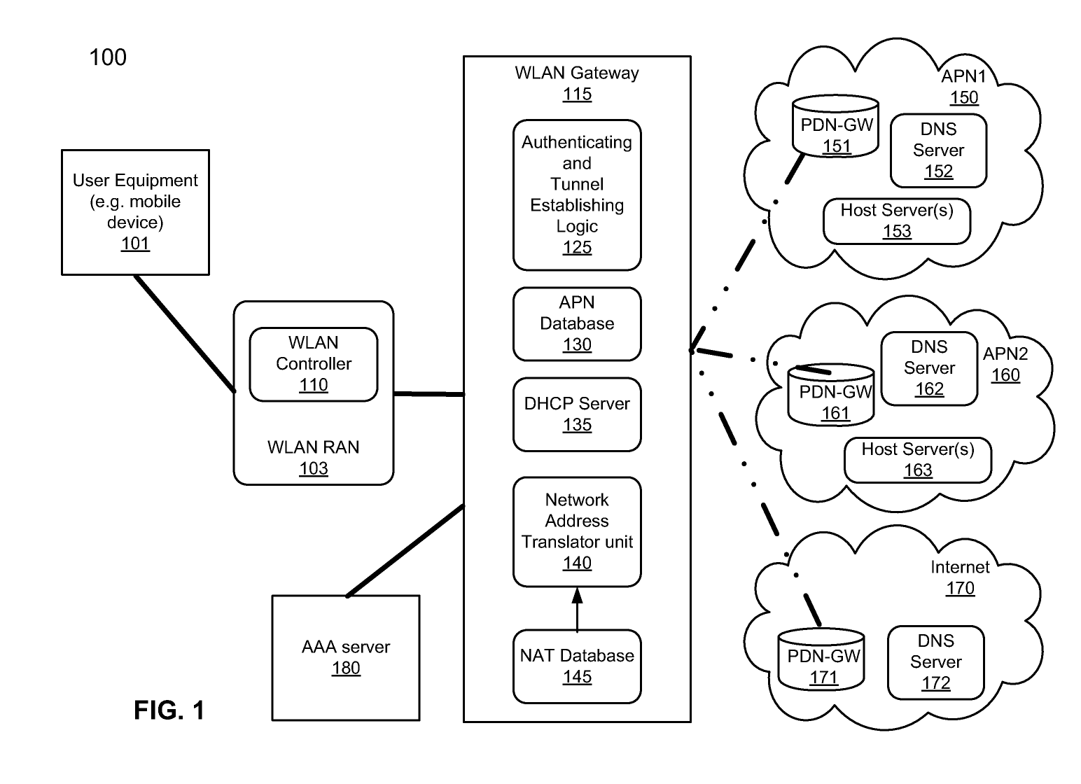

FIG. 1 is a block diagram illustrating an internetworked WLAN and WWAN system according to one embodiment. Referring to FIG. 1, user equipment (UE) 101 is communicatively coupled to WLAN controller 110 of WLAN radio access network (RAN) 103. UE 101 may be any of a variety of mobile devices, such as a Smartphone, tablet, a laptop, a gaming device, and/or a media device, etc. In order to access other networks such as Internet 170, MNO APNs, such as APN1 150 and/or APN2 160, UE 101 has to go through WLAN gateway (WGW) 115, which includes logic for APN and IP management, details of which are discussed below.

In one embodiment, WGW 115 is communicatively coupled to a mobile packet core network comprising of one or more APNs. Each APN includes a gateway, such as a PDN GW, that interfaces with WGW 115, allowing UEs to communicate with host servers hosting services that UE wishes to access. By way of example, FIG. 1 illustrates WGW 115 communicatively coupled to a packet core network comprising of two APNs, APN1 150 and APN2 160. WGW 115 interfaces with PDN GW 151 to enable UEs to access services hosted on host server(s) 153 of APN1 150. As illustrated in FIG. 1, WGW 115 also interfaces with PDN GW 161 to enable UEs to access services hosted on host server(s) 163 of APN2 160.

In one embodiment, when a UE moves within WLAN RAN 103 (e.g., a Wi-Fi hotspot), it attempts to connect with a packet core network, for instance, by transmitting a DHCP request to WGW 115 through WLAN controller 110. In one embodiment, WGW 115 includes, but is not limited to, authenticating and tunnel establishing logic (ATEL) 125 for invoking an AAA server, such as AAA server 180, to authenticate UE 101. In one embodiment, every successfully authenticated DE is granted default permissions, i.e., access to Internet 170. However, access to other MNO hosted services, e.g., those hosted on host server(s) 153 and 163 of APN1 150 and APN2 160, respectively, are permitted according to the service level the UE is eligible for, based on information maintained by AAA server 180. In one embodiment, AAA server 180 returns a set of one or more APNs of one or more hosted services that UE 101 is allowed to access. By way of example, if UE 101 is permitted to access services hosted on host servers 153 of APN1 150, AAA server 180 would return the APN corresponding to APN1 150. In one embodiment, the corresponding domain names and/or IP subnet addresses of the accessible host servers hosting the services are also provided by AAA server 180. Thus, continuing on with the above example, AAA server 180 would also return the domain names and/or IP subnet addresses corresponding to host servers 153. Accordingly, in one embodiment, the IP subnet addresses returned by AAA server 180 correspond to the IP addresses of the servers hosting the services that the UE is permitted to access, and the domain names returned by AAA server 180 are the equivalent text string representation of the IP subnet addresses. In one embodiment, the APNs, the corresponding domain names and/or IP subnet addresses are maintained by WGW 115 in an APN database, such as APN database 130.

Once authenticated, the UE may move in and out of WLAN RAN 103 (e.g., a Wi-Fi device moving in and out of Wi-Fi hotspots), and each time the UE moves back within WLAN RAN 103, it attempts to re-authenticate with the packet core network. This results in a signaling storm on the packet core network when the UE constantly roams in and out of WLAN 103. However, according to one embodiment of the invention, WGW 115 caches the authentication information of the UEs, such that when they move back within WLAN RAN 103, WGW 115 simply uses the cached information rather than re-invoking AAA server 180. Under such an embodiment, the packet core network avoids unnecessary loading when UEs roams around. In one embodiment, the cached authentication information of a UE times out after a predetermined period of inactivity from the UE, and authentication is re-invoked when the UE moves back within WLAN RAN 103.

In one embodiment, after successfully authenticating with AAA server 180, and in response to the DHCP request from UE 101, DHCP server 135 within WGW 115 selects an unused/unallocated UE LIP address from a pool of UE LIP addresses and assigns it to UE 101, which is communicated to the UE by WGW 115, e.g., by transmitting it in a DHCP response to WLAN controller 110. In one embodiment, the assigned UE LIP address is used by WLAN controller 110 to identify traffic to/from the UE while the UE is communicatively coupled to the WLAN and exchange the UE traffic between WGW and WLAN controller. In one embodiment, the allocated UE LIP is also maintained in network address translator (NAT) database 145 within WGW 115. Thus, according to this embodiment, the signaling overhead to the packet core network is avoided because WGW 115 has taken on the burden of allocating the UE with a LIP address, and the IP address allocation is transparent to the packet core network. The avoidance of such overhead is most useful in cases where the UE constantly roams around and moves in and out of hotspots, thus, constantly requesting for new IP addresses, without ever establishing any IP session with the packet core network. In other words, WGW 115 helps to prevent dormant UEs such as Wi-Fi devices passing through Wi-Fi hotspots from unnecessarily overwhelming the packet core network.

In one embodiment, once authenticated, UE 101 attempts to access a service hosted by an MNO's APN host server by sending a DNS request for an IP address of the desired domain name, i.e., the host server hosting the requested service. Upon receiving the DNS request, WGW 115 determines whether UE 101 is permitted to access the desired domain, i.e., whether the UE has permission to access the hosted service. In one embodiment, WGW 115 determines that UE 101 is permitted access to the desired domain if the desired domain is within the range of domains in APN database 130.

According to one embodiment, if WGW 115 determines that UE 101 is not permitted to access the requested service, WGW 115 blocks the DNS request from being forwarded to the packet core network, thus avoiding the unnecessary loading on the core network.

In one embodiment, if WGW 115 determines that UE 101 is permitted to access the requested service, WGW 115 determines the APN of the service according to the information in APN database 130. In one embodiment, WGW 115 identifies a PDN GW based on the APN, and determines if a tunnel exists between WGW 115 and the identified PDN GW. In one embodiment, if a tunnel does not already exist, WGW 115, for example, ATEL 125 of WGW 115, establishes a tunnel, e.g., a GPRS tunneling protocol user plane (GTP-U) tunnel, with the identified PDN GW. During the GTP-U tunnel establishment, the PDN GW assigns an external IP address to the UE, which is maintained by WGW 115 in NAT database 145 as a PDN GW assigned IP (PAIP) address, at an entry corresponding to the LIP address of the UE. In one embodiment, the information maintained in NAT database 145 is used by WGW 115 for performing network address translation, which is described in further details below.

In one embodiment, the DNS request from UE 101 is forwarded to the PDN GW which, in turn, responds by sending a DNS response, containing the IP address of the desired domain name, i.e., host server hosting the requested service, such as host servers 153 of network APN1 150 or host servers 163 of network APN2 160. In one embodiment, the IP address is provided by a DNS server within the network that hosts the service, e.g., DNS server 152 of network APN1 150, or DNS server 162 of network APN2 160. In one embodiment, subsequent communication between UE 101 and the desired domain (host server) passes through WGW 115, which includes network address translator (NAT) unit 140 for translating/replacing the PAIP address assigned to UE 101 by the PDN GW with the LIP address assigned to UE 101 by the WGW in the downlink traffic. In one embodiment, NAT unit 140 is also configured to replace, in the uplink traffic, the LIP address assigned to UE 101 by the WGW with the PAIP address assigned to UE 101 by the PDN GW.

In one embodiment, when the last IP session is terminated, e.g., by the PDN GW, UE, or timeout, the GTP-U tunnel between WGW 115 and corresponding PDN GW is torn down. In one embodiment, WGW 115 will also release the PAIP assigned to the UE by the DHCP server of the corresponding PDN, e.g., by sending a message to the PDN GW indicating that the tunnel should be torn down. In one embodiment, WGW 115 also releases the LIP assigned by DHCP server 135 of WGW 115, e.g., by removing the UE LIP from NAT database 145 and/or removing the UE LIP from APN database 130.

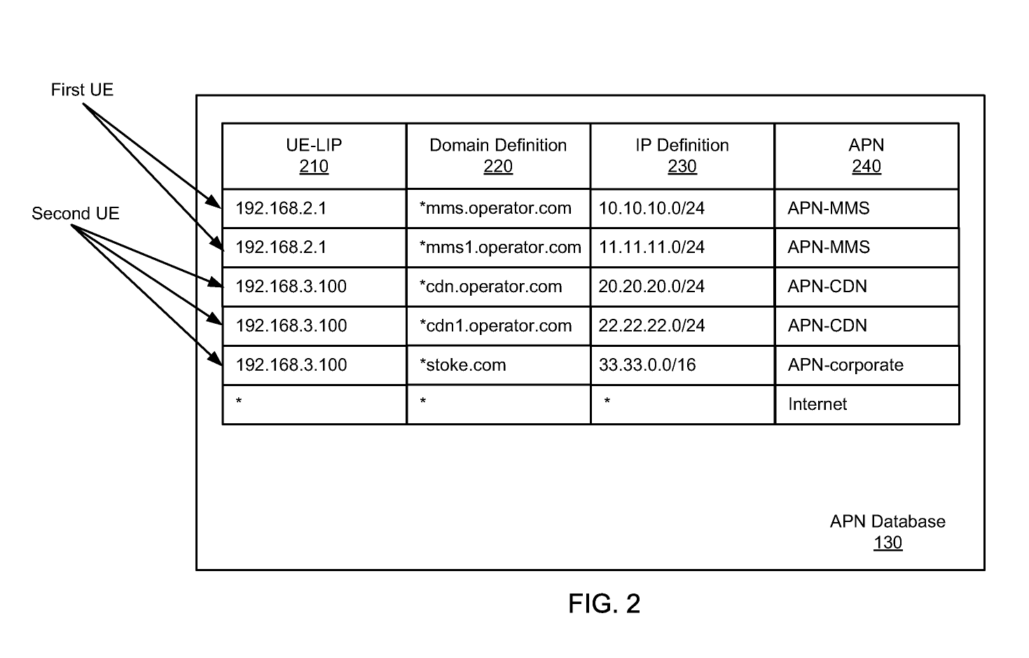

FIG. 2 is a block diagram illustrating an embodiment of APN database 130 of FIG. 1. Referring now to FIG. 2, APN database 130 includes one or more entries of UE LIP 210, which identifies the UE LIP addresses that have been assigned to the UEs by DHCP server 135 within WGW 115 of FIG. 1. Referring back to FIG. 2, in one embodiment, entry 210 of APN database 130 identifies the UEs that have been successfully authenticated and granted access to the Internet and/or granted access to MNO hosted services. As illustrated in FIG. 2, two UEs have been successfully authenticated; the first authenticated UE having the UE LIP address of 192.168.2.1, and the second successfully authenticated UE having the UE LIP address of 192.168.3.100.

In one embodiment, APN database 130 includes one or more entries of domain definition 220, which identifies the range of domain names (i.e., host servers of services) that a successfully authenticated UE may access. In one embodiment, a successfully authenticated UE may be granted access to one or more hosted services, or it may not be granted access to any hosted services at all. However, in one embodiment, authenticated UEs are granted access to at least the Internet. By way of example, as illustrated in FIG. 2, the first authenticated UE identified by UE LIP address 192.168.2.1 has been granted access to domains “*mms.operator.com”, “*mms1.operator.com”, in addition to the default access to the Internet, as identified by domain definition “*”, and the second authenticated UE identified by UE LIP address 192.168.3.100 has been granted access to domains “*cdn.operator.com”, “*cnd1.operator.com”, “stoke.com”, in addition to the default access to the Internet identified by domain definition “*”.

In one embodiment, APN database 130 includes one or more entries of IP definition 230 which is a numerical equivalent of the text string representation of domain names in entry domain definition 220. Thus, for example, the range of domain names “*mms.operator.com” is numerically represented as an IP subnet address “10.10.10.0/24”, where the “24” indicates that only the 24 most significant bits (MSB) of the IP address identified in IP definition 230 are compared against the destination IP address of frames transmitted by a UE to a host server or against the source IP address of frames transmitted by a host server to the UE. Thus, “10.10.10.0/24” represents a range of IP addresses of host servers hosting the services that the DE is allowed to access. Accordingly, in embodiments of APN database 130 that include both entry domain definition 220 and entry IP definition 230, WGW 115 is capable of processing packets to/from the UE that include domains either represented by a text string or a numeric.

In one embodiment, APN database 130 includes one or more entries of APN 240, which identifies the APN that includes one or more host servers (as identified by entries 220 and/or 230 of the APN database) that host the one or more services that the UE (as identified by entry 210 of the APN database) is allowed to access. In one embodiment, an APN may be associated with one or more host servers. By way of example, as illustrated in FIG. 2, APN-MMS is an APN that includes at least host servers with the range of domain names “*MMS operatoncom” and “*mms1.operator.com”, or numerically represented by “10.10.10.0/24” and “11.11.11.0/24”, respectively.

According to one embodiment, an entry of APN database 130 may time out after a predetermined period of inactivity between the corresponding UE and APN. In such a case, the timed-out entry may be removed from APN database 130. In one embodiment, an entry may also be removed from APN database 130 if the last IP session between the UE and APN is terminated, either by the corresponding PDN GW and/or UE.

The above description of APN database 130 is only intended for illustrative purposes. APN database 130 is not limited to the entries described above. APN database 130 of the present invention may include more or less entries than those described above. In one embodiment, WGW 115 may include one or more of such APN database 130. By way of example, in one embodiment, APN database 130 may not include entry 210. In such an embodiment, WGW 115 may include multiple APN databases, each corresponding to one or more UEs. The choice of which entries to include in APN database 130 is implementation specific, and the present invention is not limited to any particular number or type of entries in the APN database.

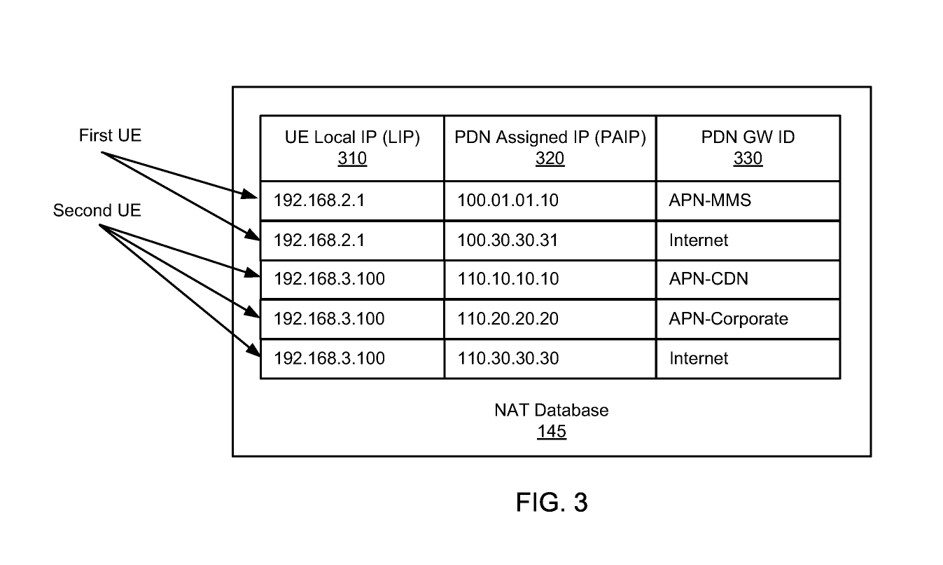

FIG. 3 is a block diagram illustrating an embodiment of NAT database 145 of FIG. 1. Referring now to FIG. 3, NAT database 145 includes one or more entries of UE LIP 310, which identifies the UE LIP addresses that have been assigned to the UEs by DHCP server 135 of FIG. 1. Referring now to FIG. 3, according to one embodiment, UE LIP 310 contains the same number of UEs as entry UE LIP 210 of APN database 130 of FIG. 2. As illustrated in FIGS. 2 and 3, there are two authenticated UEs.

Referring now to FIG. 3, according to one embodiment, NAT database 145 includes one or more entries PDN assigned IP (PAIP) address 320, which identifies the external IP addresses that have been assigned to the authenticated UEs identified by the corresponding entry UE LIP 310. By way of example, as illustrated in FIG. 3, a first UE has been assigned an UE LIP address of “192.168.2.1” by DHCP server 135 of FIG. 1, and has a corresponding PAIP address of “100.01.01.10”, assigned by a PDN GW corresponding to APN-MMS. Note that, as illustrated in FIG. 3, the first UE is associated with two corresponding PAIP addresses of “100.01.01.10” and “100.30.30.31”. Thus, the first UE can access one APN, in addition to the Internet. Note further that, as illustrated in FIG. 3, a second UE is assigned a LIP address of “192.168.3.100” by DHCP server 135 of FIG. 1, and has three corresponding PAIP addresses of “110.10.10.10”, “110.20.20.20”, and “110.30.30.30”. Thus, the second UE can access two APNs in addition to the Internet.

In one embodiment, NAT database 145 includes one or more entries of PDN GW ID 330, which identifies the PDN GW that assigned the PAIP as identified by entry 320 to the UE identified by entry 310. By way of example, as illustrated in FIG. 3, the PDN GW corresponding to APN-MMS assigned the IP address of “100.01.01.10” (the first PAIP address of entry 320) to the UE having a LIP address of “192.168.2.1” (the first LIP address of entry 310).

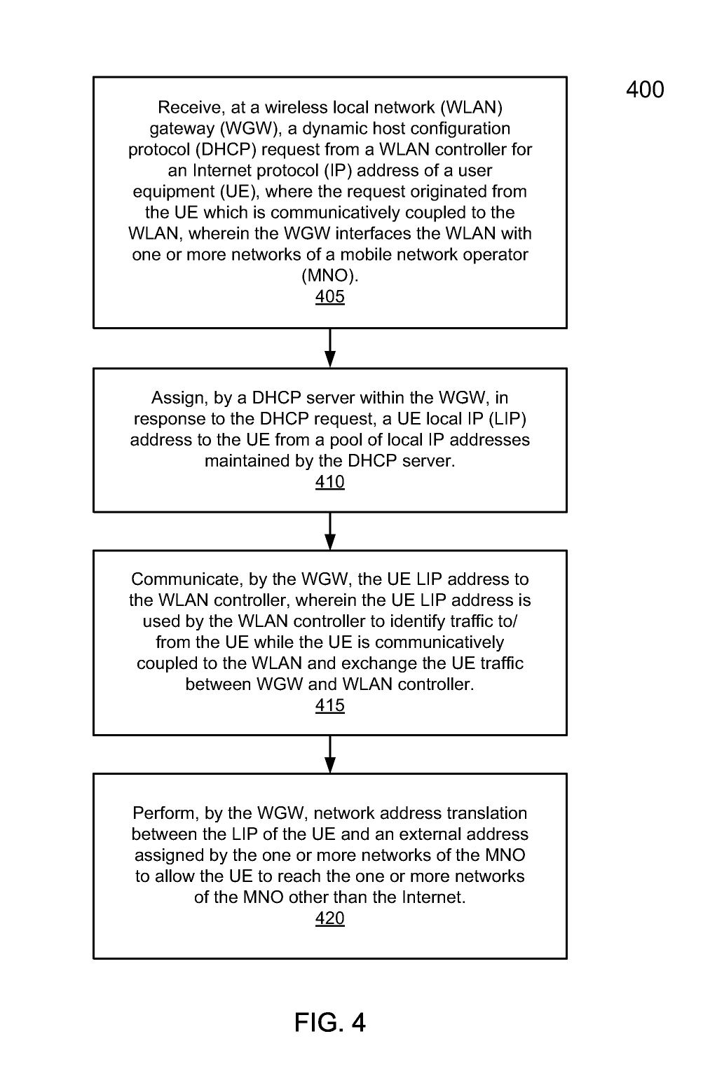

FIG. 4 is a flow diagram illustrating a method 400 for performing network address translation to enable a UE to reach one or more APNs in addition to the Internet. For example, method 400 may be performed by WGW 115 of FIG. 1. Referring now to FIG. 4, at block 405, WGW receives a DHCP request from a WLAN controller (e.g., WLAN controller 110 of FIG. 1) for an IP address of a UE (e.g., UE 101 of FIG. 1), where the request originated from the UE which is communicatively coupled to the WLAN (e.g., WLAN RAN 103 of FIG. 1) wherein the WGW interfaces the WLAN with one or more networks (e.g., APN1 150 and/or APN2 160 of FIG. 1) of an MNO.

At block 410, a DHCP server within WGW (e.g., DHCP server 135 of FIG. 1) assigns, in response to the DHCP request, a UE LIP address to the UE from a pool of local IP addresses maintained by the DHCP server. According to one embodiment, WGW also maintains the assigned UE LIP in a database, such as NAT database 145 of FIG. 1.

At block 415, WGW communicates the UE LIP address to the WLAN controller, e.g., by transmitting the UE LIP in a DHCP response to the WLAN controller. In one embodiment, the UE LIP address is used by the WLAN controller to identify traffic to/from the UE while the UE is communicatively coupled to the WLAN and exchange the UE traffic between WGW and WLAN controller.

At block 420, WGW performs network address translation between the LIP address of the UE and an external IP address assigned by one or more networks of the MNO to allow the UE to reach the one or more networks of the MNO in addition to the Internet. According to one embodiment, WGW performs network address translation of packets transmitted to/from UE by performing two operations. During the first operation, WGW compares the destination or source IP address as indicated in a packet to/from the UE against domain definition 220 and/or IP definition 230 of FIG. 2, to determine a corresponding APN. During the second operation, WGW performs network address translation using a NAT database, such as NAT database 145 of FIG. 3, based on destination or source IP address in the packet and the APN determined during the first operation. By way of example, consider an uplink packet transmitted by a UE (with a LIP address of “192.168.2.1”), destined for a host server (with a domain name “blah.mms.operator.com”). When the uplink packet arrives at WGW 115 from a WLAN controller, it will have a source IP address of “192.168.2.1” and a destination IP address or domain name corresponding to “blah.mms.operator.com”. Assuming the APN database is configured as illustrated in FIG. 2, during the first operation, WGW determines that the corresponding APN is APN-MMS because “blah.mms.operator.com” is within the range of “*mms.operator.com”, and the source IP address of the packet matches the LIP address of “192.168.2.1” as indicated by entry 210 of APN database 130 of FIG. 2. In other words, the combination of the received source IP address and destination domain name results in a match of the first row of APN database 130 illustrated in FIG. 2. Thus, WGW 115 determines that the packet is to be transmitted to a PDN GW corresponding to APN-MMS. Assuming the NAT database is configured as illustrated in FIG. 3, during the second operation, WGW translates the source IP address of “192.168.2.1” (the UE LIP address) to the corresponding PAIP, i.e., “100.01.01.10” using NAT database 130. In one embodiment, WGW 115 uses the source IP address (192.168.2.1) from the uplink packet and the APN-MMS determined during the first operation, and determines that the combination of the source IP address and the APN results in a match of the first row of NAT database 145. In other words, source IP address of 192.168.2.1 matches the first IP address of entry LIP 310 and the APN-MMS matches the first APN of entry PDN GW 330. As a result, WGW 115 translates the source IP address of 192.168.2.1 to the first external IP address of entry PAIP 320, i.e., 100.01.01.10.

Consider now a downlink packet transmitted by the same host server to the same UE as described above. In this case, when the downlink packet arrives at WGW 115 from the PDN GW, it will have a source IP address of “blah.mms.operator.com” and a destination IP address of 100.01.01.10. During the first operation, WGW 115 determines that “blah.mms.operator.com” is within the first range of domain definition 220 of APN database 130, and thus, WGW 115 determines that the downlink packet was transmitted by a PDN GW corresponding to APN-MMS. During the second operation, WGW 115 determines that the destination IP address of the downlink packet (100.01.01.10) matches the first IP address of entry PAIP 320, and APN-MMS matches the first APN of entry PDN GW 330 of NAT database 145. In other words, the combination of the destination IP address and the APN derived in the first operation results in a match of the first row of NAT database 145 as illustrated in FIG. 3. As a result, WGW 115 translates the destination IP address from PAIP address of 100.01.01.10 to UE LIP address of 192.168.2.1, the first IP address of entry UE LIP 310 of NAT database 145.

The above description of NAT is only intended for illustrative purposes. WGW 115 is not limited to performing NAT using the operations discussed above. WGW 115 of the present invention may use any NAT algorithm known in the art, which may include more or less operations than those described above.

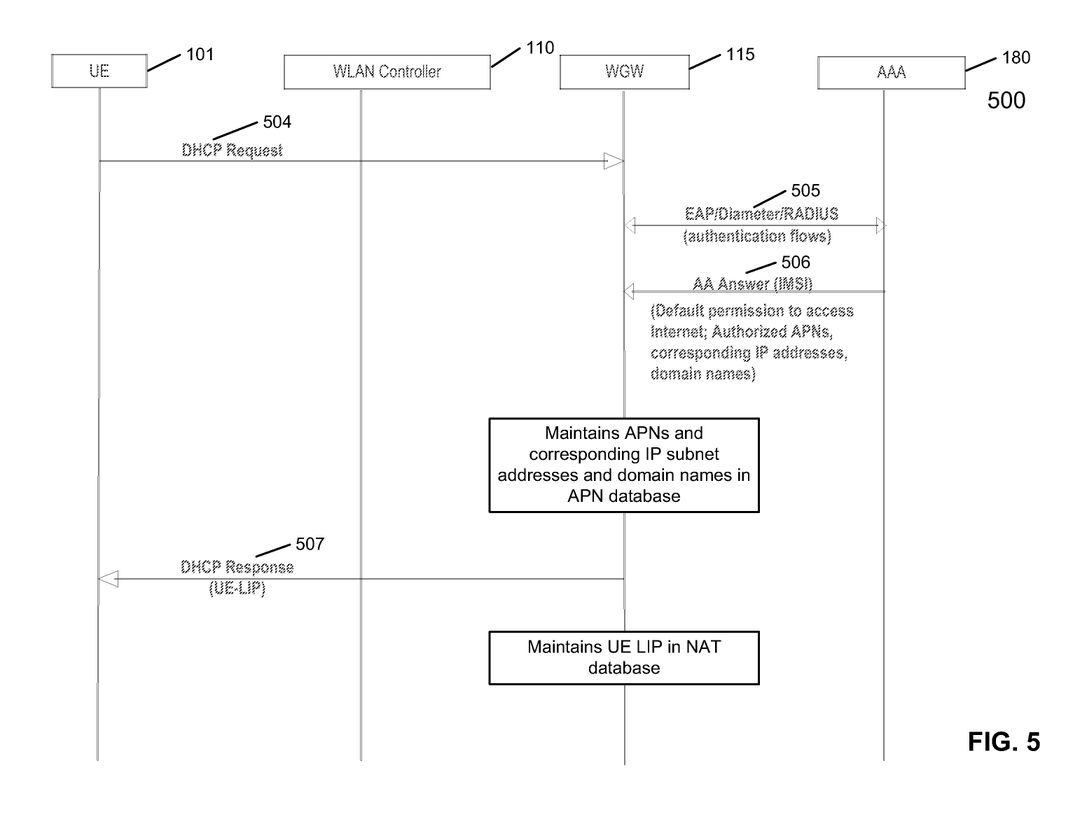

FIG. 5 is a transaction diagram illustrating a processing flow for authenticating and assigning a LIP address to a UE according to one embodiment of the invention. At transaction 504, UE 101 transmits a DHCP request to WGW 115. At transaction 505, WGW is triggered by the DHCP request of transaction 504 to initiate an authentication of UE 101 with AAA 180. In one embodiment, the authentication is performed using the extensible authentication protocol (EAP) which may be based on either the diameter protocol or remote authentication dial-in user service (RADIUS) protocol. At transaction 506, the authentication process is successfully completed when AAA 180 sends an AA Answer to WGW 115. In one embodiment, the AA Answer includes information granting the authenticated UE default permission to access the Internet. In one embodiment, AAA server 180 determines whether the UE is authorized to access one or more hosted services. If the UE is determined to have authorized access to one or more hosted services, AAA server 180 includes in the AA Answer the one or more APNs of the one or more hosted services that the UE is permitted to access. According to one aspect of the invention, AAA server 180 also sends WGW 115 one or more domain names of the host servers that host the services that the UE is permitted to access. In one embodiment, AAA server 180 sends WGW 115 the IP subnet addresses of the host servers hosting the services that the UE is permitted to access. In some embodiments, both the range of domain names and IP subnet addresses are transmitted by AAA server 180 to WGW 115. In other embodiments, AAA server 180 transmits one or the other, but not both, to WGW 115.

According to one embodiment, WGW 115 stores the APNs and corresponding range of domain names and/or IP subnet addresses in an APN database, such as APN database 130 of FIG. 1. At transaction 507, once the UE has been properly authenticated, WGW 115 sends a DHCP response containing a LIP address to UE 101. In one embodiment, the LIP address is assigned by a DHCP server within WGW 115, such as DHCP server 135 of FIG. 1. In one embodiment, the assigned UE LIP is also maintained by WGW 115 in a NAT database such as NAT database 145 of FIG. 1.

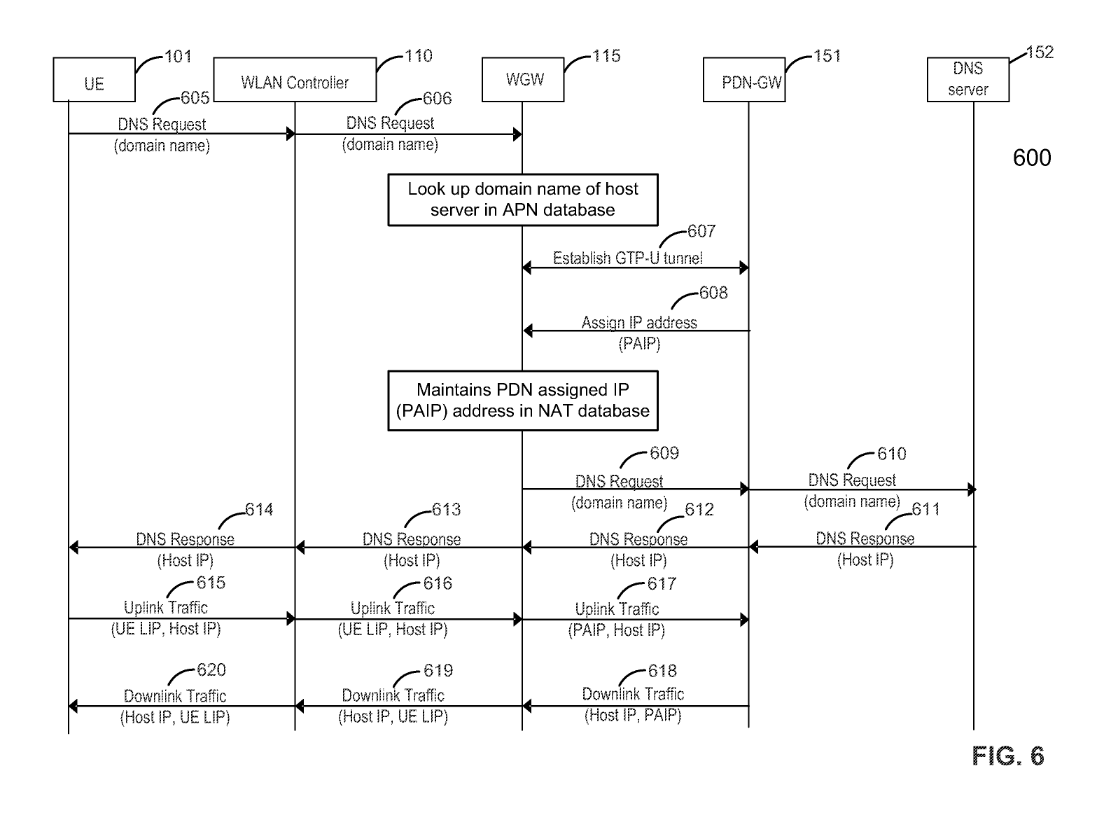

FIG. 6 is a transaction diagram illustrating a process flow for data traffic to be exchanged between a UE and a host server according to one embodiment. Process flow 600 assumes that some, if not all, of the transactions of process flow 500 of FIG. 5 have been completed. For instance, at the minimum, the UE has been assigned a local IP address by a DHCP server within WGW. Referring now to FIG. 6, at transaction 605, UE 101 determines that it needs to access a hosted service and transmits a DNS request for IP address of a domain name, i.e., the host server hosting the service. At transaction 606, WLAN controller 110 receives and forwards the DNS request to WGW 115. According to one embodiment, WGW determines if UE 101 has permission to access the requested hosted service by performing a lookup of the domain name in an APN database, such as APN database 130 of FIG. 1. According to one embodiment, WGW 115 determines that UE 101 has permission to access the hosted service if the domain name in the DNS request is within a range of domain names associated with the UE according to information in the APN database. According to one embodiment, WGW 115 determines the APN of the hosted service according to information in the APN database. At transaction 607, after determining that UE 101 has permission to access the hosted service, and after determining that there is no existing tunnel between WGW 115 and the PDN GW corresponding to the APN of the hosted service, WGW 115 establishes a GTP-U tunnel with the corresponding PDN GW, e.g., PDN GW 151 of FIG. 1. Referring back to FIG. 6, at transaction 608, the GTP-U tunnel is established, and PDN GW 151 transmits a PAIP address to UE 101. In one embodiment, the PAIP is maintained by WGW 115 in a NAT database such as NAT database 145 of FIG. 1. At transaction 609, the DNS request received by WGW 115 at transaction 606 is forwarded to PDN GW 151. In one embodiment, WGW 115 performs network address translation on the DNS request message prior to forwarding it to PDN-GW 151. For example, the source IP address of the DNS request is translated from the UE LIP address to the corresponding PDN-GW assigned external IP address. At transaction 610, PDN-GW 151 relays the DNS request to its local DNS server, such as DNS server 152 of FIG. 1. In response, at transaction 611, DNS server 152 provides an IP address for the requested domain name in the DNS request. In other words, at transaction 611, DNS server 152 provides the IP address of the host server hosting the service that UE 101 would like to access. At transaction 612, PDN GW 151 communicates the IP address of the requested domain name to UE 101, e.g., by transmitting it in a DNS response to WGW 115. According to one embodiment, WGW 115 performs network address translation on the DNS response before forwarding it to the UE at transactions 613-614. For example, WGW 115 translates the destination IP address from the PDN-GW assigned IP address to the corresponding UE LIP address.

According to one embodiment, subsequent communication between UE 101 and the host server hosting the service passes through WGW 115. For example, transactions 615-617 illustrate the flow of uplink traffic, i.e., traffic from UE 101 to the host server, and transactions 618-620 illustrate the flow of downlink traffic, i.e., traffic from the host server to UE 101. In these transactions, the first IP address in the parenthesis indicates the source address, and the second IP address is the destination address. Thus, at transaction 615, UE 101 sends one or more uplink packets to the host server (not shown) via WLAN controller 110, WGW 115, and PDN GW 151, with the source IP address of “UE LIP” address and the destination IP address of “host IP”. In one embodiment, the UE LIP address is the LIP address assigned by a DHCP server within WGW 115, such as DHCP server 135 of FIG. 1. By way of example, the UE LIP address may be the UE LIP address obtained by UE 101 during transaction 510 of FIG. 5. The host IP address may be an IP address provided by a DNS server of an APN, such as DNS server 152 at transaction 611 described above and received by UE 101 at transaction 614. At transaction 616, the uplink traffic from UE 101 is forwarded to WGW 115 by WLAN controller 110. In one embodiment, WGW 115 performs NAT using, for example, the NAT algorithm discussed above, or any other NAT algorithms known in the art. As a result of NAT, the source address of the uplink packets are translated from “UE LIP” address to “PAIP” address, which is the IP address of the UE assigned by the PDN GW, for example, at transaction 608 discussed above. At transaction 617, WGW 115 forwards the modified uplink packet to PDN GW 151 which relays it to the host server (not shown) corresponding to the host IP address indicated in the packet.

At transaction 618, PDN GW 151 forwards downlink traffic from a host server to WGW 115, destined for UE 101. In one embodiment, the downlink packets include source address of “host IP” address, and a destination address of “PAIP” address. In one embodiment, the host IP address is the IP address generated at transaction 611 and PAIP address is the IP address assigned to UE 101 at transaction 608. In one embodiment, WGW 115 performs NAT on the downlink packets using the NAT algorithm discussed above, or any other NAT algorithm well known in the art. As a result of the NAT operation, the destination IP address is translated from “PAIP” address to “UE LIP” address, and the downlink packets are forwarded to UE 101 via transactions 619-620.

Although process flow 600 of FIG. 6 illustrates communication between UE 101 and PDN GW 151, it will be appreciated that the transactions are only intended for illustrative purposes. In particular, the present invention is not limited to the communication between one UE and one PDN GW. For example, multiple UEs may communicate with a single PDN GW to access a single APN, and/or a single UE may communicate with multiple PDN GWs to access multiple APNs, or any combination thereof, thus allowing a UE to reach one or more APNs in addition to the Internet.

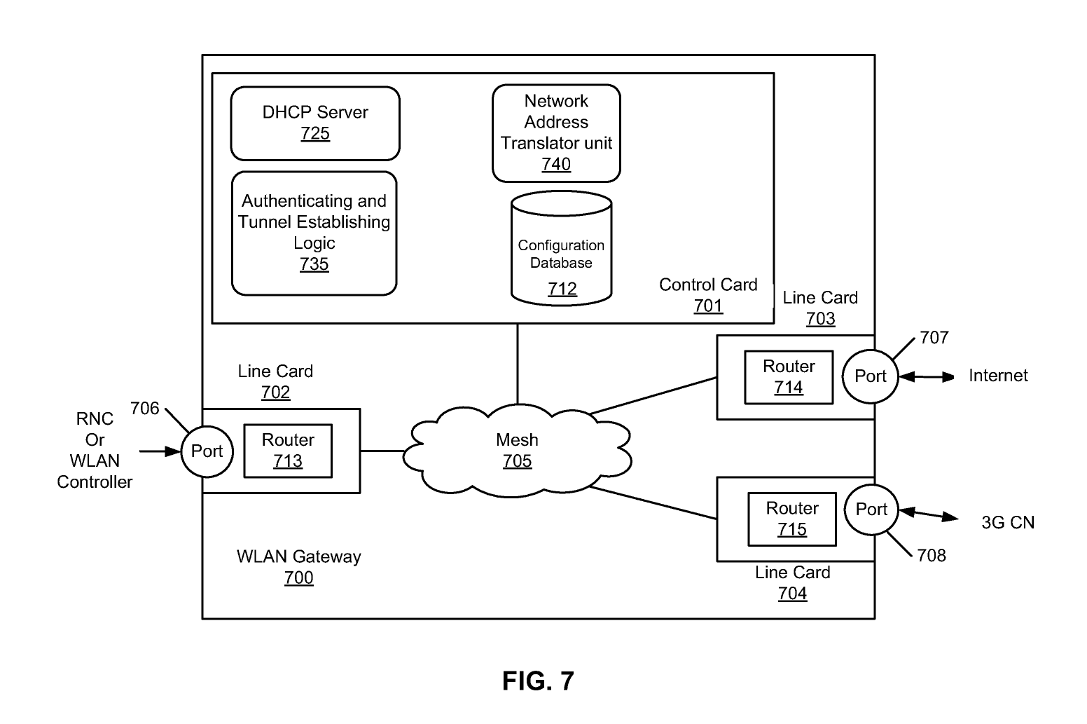

FIG. 7 is a block diagram illustrating a WLAN gateway device according to one embodiment of the invention. For example, WGW 700 may be implemented as a part of WGW 115 of FIG. 1. Referring to FIG. 7, WGW 700 includes, but is not limited to, a control card 701 (also referred to as a control plane) communicatively coupled to one or more line cards 702-704 (also referred to as interface cards or user planes) over a mesh 705, which may be a mesh network, an interconnect, a bus, or a combination thereof. Each of the line cards 703-704 is associated with one or more interfaces (also referred to as ports), such as interfaces 706-708 respectively. Each line card includes routing functional block (e.g., blocks 713-715) to route packets via the corresponding interface according to a configuration (e.g., routing table) configured by control card 701. For the purpose of illustration, it is assumed that interface 706 is to be coupled to an RNC of a 3G RAN or a WLAN controller of a WLAN RAN; interface 707 is to be coupled to the Internet; and interface 708 is to be coupled to SGSN of a 3G packet core network for operator services.

According to one embodiment, control card 701 includes configuration database 712, DHCP server 725, authentication and tunnel establishing logic (ATEL) 735, and network address translator (NAT) unit 740. In one embodiment, configuration database 712 may be utilized to store an APN database such as APN database 130 of FIG. 2, and/or a NAT database such as NAT database 145 of FIG. 3. At least a portion of information stored in database 712 may be pushed down to line cards 702-704, for example, as part of a routing table (not shown).

In one embodiment, DHCP server 725 is configured to perform functions similar to those performed by DHCP server 125 of FIG. 1, e.g., allocating and assigning a LIP address to a UE, such as UE 101 of FIG. 1, in response to a DHCP request received by WGW 700 from the UE. In one embodiment, the LIP address is selected from a pool of unused LIP addresses, which may be stored in configuration database 712.

In one embodiment, ATEL 735 is configured to perform functions similar to those performed by ATEL 135 of FIG. 1, e.g., invoking an authentication, authorization and accounting (AAA) server, such as AAA server 180 of FIG. 1, to authenticate a UE, in response to a DHCP request received from the UE. In one embodiment, ATEL 735 is also configured to establish a GTP-U tunnel with a PDN GW (e.g., through port 708) in order to tunnel traffic originated from the authenticated UE (e.g., through port 706) and the PDN GW.

In one embodiment, NAT unit 740 is configured to perform functions similar to those performed by NAT unit 140 of FIG. 1, e.g., translating between a LIP address of the UE and one or more external IP addresses assigned by one or more APNs of an MNO. In one embodiment, NAT unit 740 performs the translation using an APN database such as APN database 130 of FIG. 2 and/or a NAT database such as NAT database 145 of FIG. 3, one or both of which may be maintained in configuration database 712.

Note that some of the functionality of control card 701 may be delegated or replicated to a line card. For example, certain information of database 712 may be replicated to line cards 702-704 and stored in a storage location (not shown) within line cards 702-704. Also note that some or all of the components as shown in FIG. 7 may be implemented in hardware, software, or a combination of both.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine-implemented method for processing network traffic of a packet network, the method comprising:
receiving, at a wireless local area network (WLAN) gateway (WGW), a dynamic host configuration protocol (DHCP) request from a WLAN controller of a WLAN for an internet protocol (IP) address of a user equipment (UE) communicatively coupled to the WLAN, wherein the WGW interfaces the WLAN with one or more networks of a mobile network operator (MNO);
assigning, by a DHCP server within the WGW, in response to the DHCP request, a UE local IP (LIP) address to the UE from a pool of local IP addresses maintained by the DHCP server;
communicating, by the WGW, the UE LIP address to the WLAN controller, wherein the UE LIP address is used by the WLAN controller to identify traffic to/from the UE while the UE is communicatively coupled to the WLAN and exchange the UE traffic between WGW and WLAN controller; and
performing, by the WGW, network address translation (NAT) between the LIP of the UE and an external IP address assigned by the one or more networks of the MNO to allow the UE to reach the one or more networks of the MNO in addition to the Internet.

2. The method of claim 1, further comprising:
invoking, by the WGW, an authentication, authorization and accounting (AAA) server to authenticate the UE, in response to a DNS request received from the UE;
receiving, by the WGW, one or more access point names (APN) from the AAA server that the authenticated UE is allowed to communicate with, and a corresponding range of domain names, and corresponding external IP subnet addresses; and
maintaining, by the WGW, an APN database comprising of the one or more APNs and their corresponding range of domain names and corresponding IP subnet addresses.

3. The method of claim 2, further comprising:
receiving, at the WGW, a domain name system (DNS) request from the WLAN controller for an IP address corresponding to a first domain name, the request originated from the UE;
determining, by the WGW, whether the first domain name exists in the APN database; and
identifying, by the WGW, in response to determining that the first domain name exists in the APN database, a first APN in the APN database corresponding to the first domain name.

4. The method of claim 3, further comprising:
sending, by the WGW, a request to a first packet data network (PDN) gateway (PDG GW) corresponding to the first APN for an external IP address to be assigned to the UE; and
receiving, at the WGW, a first external IP address from the first PDN GW, wherein the first external IP address is used by the WGW to identify traffic to/from the UE while the UE is communicatively coupled to the WLAN and tunnel the UE traffic between WGW and the first PDN GW.

5. The method of claim 4, further comprising:
identifying, by the WGW, downlink traffic to the UE based on the first external IP address;
modifying, by the WGW, the identified downlink traffic by replacing the first external IP address with the UE LIP address as a destination address in the identified downlink traffic; and
transmitting, by the WGW, the modified downlink traffic to the WLAN controller.

6. The method of claim 4, further comprising:
identifying, by the WGW, uplink traffic from the UE based on the UE LIP address;
modifying, by the WGW, the identified uplink traffic by replacing the UE LIP address with the first external IP address as a source address; and
tunneling, by the WGW, the modified uplink traffic to the first PDN GW.

7. The method of claim 4, further comprising:
sending, by the WGW, the DNS request to the first PDN GW corresponding to the first APN for an external IP address corresponding to the first domain name;
receiving, at the WGW, a second external IP address from the first PDN GW, wherein the second external IP address is an IP address corresponding to the first domain name; and
forwarding, by the WGW, the second external IP address to the WLAN controller.

8. A wireless local area network (WLAN) gateway (WGW) , comprising:
an interface to receive a dynamic host configuration protocol (DHCP) request from a WLAN controller of a WLAN for an internet protocol (IP) address of a user equipment (UE) communicatively coupled to the WLAN, wherein the WGW interfaces the WLAN with one or more networks of a mobile network operator (MO);
a DHCP server, in response to the DHCP request, to assign a UE local IP (LIP) address to the UE from a pool of local IP addresses maintained by the DHCP server, and to communicate the UE LIP address to the WLAN controller, wherein the UE LIP address is used by the WLAN controller to identify traffic to/from the UE while the UE is communicatively coupled to the WLAN and exchange the UE traffic between WGW and WLAN controller; and
a network address translator unit to perform network address translation (NAT) between the LIP of the UE and an external IP address assigned by the one or more networks of the MNO to allow the UE to reach the one or more networks of the MNO in addition to the Internet.

9. The WGW of claim 8, wherein the WGW is further configured to invoke an authentication, authorization and accounting (AAA) server to authenticate the UE, in response to a DNS request received from the UE, wherein the WGW is further configured to receive one or more access point names (APN) from the AAA server that the authenticated UE is allowed to communicate with, and a corresponding range of domain names, and corresponding external IP subnet addresses, and wherein the WGW is further configured to maintain an APN database comprising of the one or more APNs and their corresponding range of domain names and corresponding IP subnet addresses.

10. The WGW of claim 9, wherein the WGW is further configured to receive a domain name system (DNS) request from the WLAN controller for an IP address corresponding to a first domain name, the request originated from the UE, wherein the WGW is further configured to determine whether the first domain name exists in the APN database, and wherein the WGW is further configured to identify, in response to determining that the first domain name exists in the APN database, a first APN in the APN database corresponding to the first domain name.

11. The WGW of claim 10, wherein the WGW is further configured to send a request to a first packet data network (PDN) gateway (PDN GW) corresponding to the first APN for an external IP address to be assigned to the UE, and wherein the WGW is further configured to receive a first external IP address from the first PDN GW, wherein the first external IP address is used by the WGW to identify traffic to/from the UE while the UE is communicatively coupled to the WLAN and tunnel the UE traffic between WGW and the first PDN GW.

12. The WGW of claim 11, wherein the WGW is further configured to identify downlink traffic to the UE based on the first external IP address, wherein the WGW is further configured to modify the identified downlink traffic by replacing the first external IP address with the UE LIP address as a destination address in the identified downlink traffic, and wherein the WGW is further configured to transmit the modified downlink traffic to the WLAN controller.

13. The WGW of claim 11, wherein the WGW is further configured to identify uplink traffic from the UE based on the UE LIP address, wherein the WGW is further configured to modify the identified uplink traffic by replacing the UE LIP address with the first external IP address as a source address, and wherein the WGW is further configured to tunnel the modified uplink traffic to the first PDN GW.

14. The WGW of claim 11, wherein the WGW is further configured to send the DNS request to the first PDN GW corresponding to the first APN for an external IP address corresponding to the first domain name, wherein the WGW is further configured to receive a second external IP address from the first PDN GW, wherein the second external IP address is an IP address corresponding to the first domain name, and wherein the WGW is further configured to forward the second external IP address to the WLAN controller.

15. A non-transitory machine-readable storage medium storing instructions therein, which when executed by a processor, cause the processor to perform a method for processing network traffic of a packet network, the method comprising:
receiving, at a wireless local area network (WLAN) gateway (WGW), a dynamic host configuration protocol (DHCP) request from a WLAN controller of a WLAN for an internet protocol (IP) address of a user equipment (UE) communicatively coupled to the WLAN, wherein the WGW interfaces the WLAN with one or more networks of a mobile network operator (MNO);
assigning, by a DHCP server within the WGW, in response to the DHCP request, a UE local IP (LIP) address to the UE from a pool of local IP addresses maintained by the DHCP server;
communicating, by the WGW, the UE LIP address to the WLAN controller, wherein the UE LIP address is used by the WLAN controller to identify traffic to/from the UE while the UE is communicatively coupled to the WLAN and exchange the UE traffic between WGW and WLAN controller; and
performing, by the WGW, network address translation (NAT) between the LIP of the UE and an external IP address assigned by the one or more networks of the MNO to allow the UE to reach the one or more networks of the MNO in addition to the Internet.

16. The non-transitory machine-readable storage medium of claim 15, further comprising:
invoking, by the WGW, an authentication, authorization and accounting (AAA) server to authenticate the UE, in response to a DNS request received from the UE;
receiving, by the WGW, one or more access point names (APN) from the AAA server that the authenticated UE is allowed to communicate with, and a corresponding range of domain names, and corresponding external IP subnet addresses; and
maintaining, by the WGW, an APN database comprising of the one or more APNs and their corresponding range of domain names and corresponding IP subnet addresses.

17. The non-transitory machine-readable storage medium of claim 16, further comprising:
receiving, at the WGW, a domain name system (DNS) request from the WLAN controller for an IP address corresponding to a first domain name, the request originated from the UE;
determining, by the WGW, whether the first domain name exists in the APN database; and
identifying, by the WGW, in response to determining that the first domain name exists in the APN database, a first APN in the APN database corresponding to the first domain name.

18. The non-transitory machine-readable storage medium of claim 17, further comprising:
sending, by the WGW, a request to a first packet data network (PDN) gateway (PDG GW) corresponding to the first APN for an external IP address to be assigned to the UE; and
receiving, at the WGW, a first external IP address from the first PDN GW, wherein the first external IP address is used by the WGW to identify traffic to/from the UE while the UE is communicatively coupled to the WLAN and tunnel the UE traffic between WGW and the first PDN GW.

19. The non-transitory machine-readable storage medium of claim 18, further comprising:
identifying, by the WGW, downlink traffic to the UE based on the first external IP address;
modifying, by the WGW, the identified downlink traffic by replacing the first external IP address with the UE LIP address as a destination address in the identified downlink traffic; and
transmitting, by the WGW, the modified downlink traffic to the WLAN controller.

20. The non-transitory machine-readable storage medium of claim 18, further comprising:
identifying, by the WGW, uplink traffic from the UE based on the UE LIP address;
modifying, by the WGW, the identified uplink traffic by replacing the UE LIP address with the first external IP address as a source address; and
tunneling, by the WGW, the modified uplink traffic to the first PDN GW.

21. The non-transitory machine-readable storage medium of claim 14, further comprising:
sending, by the WGW, the DNS request to the first PDN GW corresponding to the first APN for an external IP address corresponding to the first domain name;
receiving, at the WGW, a second external IP address from the first PDN GW, wherein the second external IP address is an IP address corresponding to the first domain name; and
forwarding, by the WGW, the second external IP address to the WLAN controller.
